(19) United States
(12) Patent Application Publication
(10) Pub. No.: US 2006/0246767 A1
(43) Pub. Date: Nov. 2, 2006

(54) Wire-terminal element

(76) Inventor: Shigeru Suzuki, Sagamihara (JP)

Correspondence Address: 3M INNOVATIVE PROPERTIES COMPANY, PO BOX 33427, ST. PAUL, MN, 55133-3427, US

(21) Appl. No.: 10/564,022

(22) PCT Filed: Jun. 17, 2004
(86) PCT No.: PCT/US04/19385

§ 371 Date: Jun. 9, 2006

(30) Foreign Application Priority Data
Aug. 5, 2003 (JP) 2003-206088

(51) Int. Cl. H01R 4/24

(52) U.S. Cl. 439/395

(57) ABSTRACT

A wire-terminal element (10) includes a terminal attachment section (12) having an engaging element (24) mechanically attached to a terminal part, a wire connecting section (14) having flat insulation-displacing elements (30) with slot connected to an electric wire, and a wire holding section (16) having first and second holding elements (36) and (40) for holding the electric wire therebetween in a manner that the electric wire is bent nearly at right angles. The wire connecting section (14) and the wire holding section (16) are arranged to be rotated relative to each other via a joint area (22).

### FIELD OF THE INVENTION

The present invention relates to a wire-terminal element.

### BACKGROUND

There has been known a wire-terminal element having a terminal attachment section that can be easily and detachably attached to a terminal part of an electric wire to which the connection is to be made. As a terminal attachment section, there can be exemplified the one having an engaging element that mechanically engages with the terminal part (e.g., bolt and seat plate)(see, for example, Japanese Unexamined Patent Publication (Kokai) No. 9-259962). The engaging element has, for example, an annular or a branched outer shape. By fastening a bolt received in an opening thereof into a seat plate, the engaging element is firmly held between the bolt and the seat plate and is electrically connected to the terminal part. As specified under JIS:C2805 (crimp terminal for copper wires), the wire-terminal element having a terminal attachment section of this kind usually has a wire connecting section of the so-called crimp type as the wire connecting section on the side to be connected to the electric wire. The wire connecting section of the crimp type has, for example, a hollow cylindrical crimp element which receives in a cavity portion thereof a wire conductor that is exposed over a predetermined length at the end of the electric wire. The crimp element is plastically deformed by the application of pressure (i.e., caulked) so as to be electrically connected to the electric wire.

As the wire connecting section possessed by the wire-terminal element, there has further been known a wire connecting section of the so-called insulation-displacement type in addition to the above-mentioned the crimp type. The wire connecting section of the insulation-displacement type has an insulation-displacement element forming an open slot of a width smaller than the diameter of the conductor of the electric wire. The insulation-displacing element is placed in the covering of the electric wire under the application of a pressure, and the conductor is press-fitted into the slot to accomplish electric conduction. The wire connecting section of the insulation-displacement type has an advantage in that no operation is required for removing the covering from an end of the electric wire. However, the ability for maintaining the connection against the external force such as tensile force exerted on the electric wire is slightly weaker than that of the wire connecting section of the crimp type. When the wire-terminal element having the wire connecting section of the insulation-displacement type is used, a countermeasure is taken, such as providing an insulation casing accommodating the wire-terminal element with a holding section for holding the electric wire or providing the wire-terminal element itself with a similar wire holding section (see, for example, Japanese Unexamined Patent Publication (Kokai) No. 10-312838).

The wire-terminal element with the wire holding section disclosed in the Japanese Unexamined Patent Publication (Kokai) No. 10-312838 is of the form of a contactor incorporated in an electric connector, and includes a box- (female)-type contactor at an end in the lengthwise direction, a wire connecting section of the insulation-displacement type nearly at the central portion in the lengthwise direction, and a wire holding section at the other end in the lengthwise direction. The wire holding section includes a holding plate with a groove for linearly holding the electric wire that is connected to the wire connecting section by displacing the insulation, and a pair of holding pieces for holding the electric wire that has passed through the holding plate in a manner of being bent at right angles. At their initial positions, the holding pieces are extending rearward of the holding plate nearly in parallel. After having passed the electric wire in space between them, the holding pieces are bent inward to firmly embrace the covering of the electric wire. Even when an external force such as tensile force is exerted on the electric wire in this state, the external force is blocked by a region where the electric wire is bent nearly at right angles between the holding plate and the holding pieces and, hence, the external force is not directly exerted on the insulation-displaced portion.

The wire-terminal element disclosed in the above Japanese Unexamined Patent Publication (Kokai) No. 9-259962 tends to develop inconvenience inherent in the wire connecting section of the crimp type as the electric wire that is to be connected becomes thin. For example, when the wire-terminal element having a wire connecting section of the crimp type is to be mounted on the electric wire of which the electric conductor has a sectional area of as small as about 0.09 mm² (AWG (American Wire Gauge) 28), there arises a problem in that the electric conductor tends to break when removing the covering by using a wire stripper further accompanied by a cumbersome operation for connecting the electric conductor by folding it to decrease the electric resistance of the crimped portion and to prevent the conductor from escaping.

On the other hand, the wire-terminal element disclosed in Japanese Unexamined Patent Publication (Kokai) No. 10-312838 has an advantage of safely and reliably accomplishing the electric connection by using the wire connecting section of the insulation-displacement type even for the electric wires of a size of about AWG 28. With this wire-terminal element, however, the electric wire is connected to the wire connecting section by displacing the insulation and is, then, bent at right angles, passed through the pair of holding pieces of the wire holding section and, in this state, the holding pieces are bent to hold the electric wire in a bent manner. Therefore, a cumbersome operation is required for connecting the electric wires and it is estimated that a special tool is required for not damaging fine electric wires. Further, the wire-terminal element is of the form of a female-type contact, and the size becomes relatively long in the lengthwise direction due to the presence of the contact portion relative to the contact of the opposite side. Therefore, this wire-terminal element is not suited for the use where limitation is imposed on the size of space for installing the wire-terminal element.

### SUMMARY OF INVENTION

In one aspect, the present invention provides a wire-terminal element that is capable of maintaining a safe and proper electric connection to the electric wire regardless of the size of the electric wire, even when the size of the electric wire is as fine as about AWG 28, that is to be connected. The wire terminal element is capable of effectively preventing the external force (such as tensile force of the electric wire) from being directly exerted on the portion of connection to the wire conductor, which can be favorably used even where there is limitation on the size of the space for installing the wire-terminal element, and which enables the electric wire connection operation to be carried out correctly and quickly by using a general-purpose tool.

The invention provides a wire-terminal element comprising a terminal attachment section attachable to a terminal part, a wire connecting section connectable to an electric wire, and a wire holding section for holding the electric wire, characterized in that the terminal attachment section includes an engaging element engageable with the terminal part; the wire connecting section includes a slotted flat insulation-displacing element capable of conductively contacting a conductor by penetrating through a covering of the electric wire; the wire holding section includes a holding element for holding the electric wire in a bent manner; the wire connecting section and the wire holding section are arranged movably relative to each other; and the insulation-displacing element and the holding element holding the electric wire move relative to each other, so that the insulation-displacing element comes into conductive contact with the conductor of the electric wire at a distal end length adjacent to a bent region of the electric wire.

### BRIEF DESCRIPTION OF THE DRAWINGS

Embodiments of the present invention will now be described in detail with reference to the accompanying drawings. Throughout the drawings, the corresponding constituent elements are denoted by common reference numerals.

[FIG. 1] is a perspective view of a wire-terminal element according to a first embodiment of the present invention.

[FIG. 2] is a vertical sectional view of the wire-terminal element of FIG. 1.

[FIG. 3] is a front view illustrating the wire-terminal element of FIG. 1 at its preparatory position.

[FIG. 4] is a front view illustrating the wire-terminal element of FIG. 1 at a position where the connection of the electric wire is completed.

[FIG. 5] is a perspective view illustrating the wire-terminal element of FIG. 1 together with the electric wire in a state where the electric wire is being held.

[FIG. 6] is a vertical sectional view illustrating the wire-terminal element of FIG. 1 together with the electric wire in a state where the electric wire is being held.

[FIG. 7] is a perspective view illustrating the wire-terminal element of FIG. 1 together with the electric wire at a position where the connection of the electric wire is completed.

[FIG. 8] is a vertical sectional view illustrating the wire-terminal element of FIG. 1 together with the electric wire at the position where the connection of the electric wire is completed.

[FIG. 9] is a perspective view of the wire-terminal element according to a second embodiment of the present invention.

[FIG. 10] is a vertical sectional view of the wire-terminal element of FIG. 9.

[FIG. 11] is a front view illustrating the wire-terminal element of FIG. 9 at its preparatory position.

[FIG. 12] is a front view illustrating the wire-terminal element of FIG. 9 at a position where the connection of the electric wire is completed.

[FIG. 13] is a perspective view illustrating the wire-terminal element of FIG. 9 together with the electric wire in a state where the electric wire is being held.

[FIG. 14] is a vertical sectional view illustrating the wire-terminal element of FIG. 9 together with the electric wire in a state where the electric wire is being held.

[FIG. 15] is a perspective view illustrating the wire-terminal element of FIG. 9 together with the electric wire at a position where the connection of the electric wire is completed.

[FIG. 16] is a vertical sectional view illustrating the wire-terminal element of FIG. 9 together with the electric wire at the position where the connection of the electric wire is completed.

Referring to FIGS. 1 t0 4, the wire-terminal element 10 includes a terminal attachment section 12 mounted on the terminal part (not shown), a wire connecting section 14 connected to the electric wire W (FIG. 5), and a wire holding section 16 arranged so as to be moved relative to the wire connecting section 14 and for holding the electric wire W. The wire-terminal element 10 has a unitary structure that is punched in a predetermined shape from a metal plate having good electric conductivity is bent. The wire-terminal element 10 includes a first plate part 18 of an elongated shape having the terminal attachment section 12 and the wire holding section 16 arranged in a fixed manner at predetermined positions, and a second plate part 20 of an elongated shape having the wire connecting section 14 arranged in a fixed manner at a predetermined position. The first and second plate parts are disposed opposite one another. They are also capable of rotating about an integral joint area 22 at their longitudinal ends. In this embodiment, the wire connecting section 14 and the wire holding section 16 are coupled together in a manner to be rotated relative to each other.

The terminal attachment section 12 of the wire-terminal element 10 is arranged at an end region of the first plate part 18 on the side opposite to the joint area 22. The terminal attachment section 12 has an engaging element 24 that mechanically engages with the terminal part (e.g., bolt and seat plate) provided on an object to which the electric wire W is to be connected. The engaging element 24 has a pair of arms 26 of the shape of flat plates extending nearly in parallel in the lengthwise direction from the flat central region 18a of the first plate part 18, and has an open-ended opening 28 defined between the arms 26. A bolt received in the opening 28 is fastened to the seat plate of the terminal part that includes the bolt and the seat plate, whereby the arms 26 are firmly held between the bolt and the seat plate and, in this state, the engaging element 24 is electrically connected to the terminal part. In the illustrated embodiment, a step is formed between the central region 18a of the first plate part 18 and the engaging element 24. Depending upon the structure of a place where the wire-terminal element 10 is used, however, the above step may not be formed. In the present invention, further, it is also allowable to employ an engaging element of a round shape, rod shape (insertion type) or blade type (plate type) such as the one specified under, for example, JIS:C2805 (crimp terminal for copper wires) instead of the engaging element of the open-ended type that is shown.

The wire connecting section 14 of the wire-terminal element 10 is arranged at an end region of the second plate part 20 on the side opposite to the joint area 22. The wire connecting section 14 has a pair of insulation-displacing elements 30 of the shape of a flat plate with slot, that come into conductive contact with a conductor C (FIG. 6) penetrating though the covering S of the electric wire W. The insulation-displacing elements 30 extend nearly in parallel with each other in a direction to approach the first plate part 18 nearly at right angles with the central region 20a along both side edges of the flat central region 20a of the second plate part 20. Each insulation-displacing element 30 has an open slot 32 that extends aslant on the side of the joint area 22 maintaining an acute angle with respect to the main flat surface of the central region 20a that faces the first plate part 18. The slots 32 are arranged in alignment in position as viewed in a direction traversing the second plate part 20. Each slot 32 is opened in an arcuate shape on the front end side of the insulation-displacing element 30 to form an electric wire introduction edge 32a. In the present invention, it is allowed to omit either one of the pair of insulation-displacing elements 30 or to arrange three or more insulation-displacing elements 30 depending upon the reliability of connection required for the wire-terminal element and the cost of the material.

The wire holding section 16 of the wire-terminal element 10 is arranged in a fixed manner with respect to the terminal attachment section 12 in the central region 18a of the first plate part 18 and in the base end region near the joint area 22. The wire holding section 16 includes a pair of first holding elements 36 each having a rectangular through hole 34 in which the electric wire W can be inserted and a pair of second holding elements 40 each having a U-shaped groove 38 for receiving the electric wire W.

The pair of first holding elements 36 of the wire holding section 16 are extending nearly in parallel with each other in a direction to approach the second plate part 20 nearly at right angles with the central region 18a along both side edges of the central region 18a of the first plate part 18. A space is defined between the central region 18a of the first plate part 18 and the two first holding elements 36 for accommodating the pair of insulation-displacing elements 30 on the second plate part 20 and the terminal region of the electric wire W of which the insulation is to be displaced.

The through holes 34 in the pair of first holding elements 36 are arranged in alignment in position as viewed in the transverse direction of the first plate part 18. The gap between the first holding elements 36 is large enough to smoothly accept the pair of insulation-displacing elements 30 of the wire connecting section 14 therebetween. Therefore, when the wire-terminal element 10 is at a position where the connection of the electric wire is completed, the pair of insulation-displacing elements 30 of the wire connecting section 14 are arranged close to the inner sides of the pair of first holding elements 36, and the slots 32 of the two insulation-displacing elements 30 are arranged in alignment passing nearly through the centers of the through holes 34 of the first holding elements 36 (FIG. 4).

The pair of second holding elements 40 of the wire holding section 16 are extending in a direction nearly at right angles with the central region 18a on both sides of the joint area 22, and are arranged on a same virtual plane nearly at right angles with the first holding elements 36. Grooves 38 of the second holding elements 40 are arranged substantially at positions extending from the plate surfaces of the corresponding first holding elements 36 as viewed in the lengthwise direction of the first plate part 18. Therefore, while the wire-terminal element 10 is in a state of holding the electric wire as will be described later, the wire holding section 16 enables the electric wire W to be inserted in the through holes 34 in the first holding elements 36 and to be received by the groove 38 of either one of the second holding elements 40; i.e., the electric wire W is held being bent nearly at right angles between the first holding element 36 and the second holding element 40.

As described above, either one of the second holding elements 40 is used for holding the electric wire. The illustrated constitution having the pair of second holding elements 40 offers such an advantage that the position for arranging the electric wire W can be selected for the terminal part to which the connection is to be made at a site where the wire-terminal element 10 is used. Besides, a half-finished product punched from a metal plate assumes a right-and-left symmetrical shape making it easy to handle the half-finished product in a subsequent step of bending. However, the present invention may be provided with only one second holding element 40. Further, the invention may employ a single holding element such as a wall for holding the electric wire in a bent manner instead of arranging the holding elements at two separate places. Further, the electric wire may be held by the wire holding section not only being bent at nearly right angles that is shown but also being bent at an obtuse angle or at an acute angle.

In the illustrated embodiment, a rib 42 is formed as an auxiliary constituent element of the wire holding section 16 at a position between the through holes 34 of the two first holding elements 36 in the central region 18a of the first plate part 18. The rib 42 works on its upper surface (surface facing the second plate part 20) 42a to support, from the lower side, the electric wire W inserted in the through holes 34. Therefore, the upper surface 42a of the rib 42 is nearly at the same height as the lower edges of the through holes 34. The rib 42 further works to increase the strength of the first plate part 18. Slits 43 are formed among the rib 42 of the first plate part 18 and the first holding elements 36, so that the front end regions of the corresponding insulation-displacing elements 30 can be smoothly inserted therein.

The wire-terminal element 10 further has a locking section 44 for securely locking the first plate part 18 (wire holding section 16) and the second plate part 20 (wire connecting section 14) together. The locking section 44 is constituted by a pair of receiving pieces 46 formed at the edges of the pair of first holding elements 36 on the first plate part 18 on the side of the terminal attachment section 12, and a pair of pawls 48 formed in the front end regions of the second plate part 20 near the pair of insulation-displacing elements 30. The pair of receiving pieces 46 extend from the first holding elements 36 integrally therewith toward the terminal attachment section 12, and are bent at their intermediate portions in the directions to approach each other. On the other hand, the pair of pawls 48 are protruding in the transverse direction of the second plate part 20 in the end region of the second plate part 20 that is bent in a direction to approach the first plate part 18 on the end side beyond the insulation-displacing elements 30. The distance between the protruded ends of the pawls 48 is slightly larger than the gap between the two first holding elements 36. When the wire-terminal element 10 is at a position where the connection of electric wire is completed as will be described later, the locking section 44 is such that the pair of pawls 48 of the second plate part 20 are engaged at their upper edges (edges on the side of the central region 20a) 48a with the lower edges (edges on the side of the central region 18a) 46a of the pair of receiving pieces 46 of the first plate part 18, whereby the two plate parts 18 and 20 are securely locked at the position where the connection of the electric wire is completed.

Described below with reference to FIGS. 5 to 8 is a procedure for connecting (mounting) the wire-terminal element 10 constituted as described above to the electric wire W. At a preparatory position (FIGS. 1 and 3) of the wire-terminal element 10 of before being connected to the electric wire W, the central region 18a of the first plate part 18 and the central region 20a of the second plate part 20 are separated away from each other defining an acute angle via the suitably bent joint area 22. At this preparatory position, the pair of insulation-displacing elements 30 of the wire connecting section 14 are placed at positions where they are not overlapping the through holes 34 of the pair of first holding elements 36 of the wire holding section 16, and the two through holes 34 are opened substantially entirely. At the preparatory position, further, the pair of pawls 48 of the second plate part 20 are placed at positions of not interfering the pair of receiving pieces 46 of the first plate part 18.

At the preparatory position, an end region of the electric wire W that is to be connected is inserted in the two through holes 34 of the wire-terminal element 10 from the outer side of one first holding element 36, and a succeeding arbitrary portion of the electric wire W is received by the groove 38 of the second holding element 40 of the side corresponding to the first holding element 36 in which the terminal region is inserted first. Then, the electric wire W is held in a state of being bent nearly at right angles between the first holding element 36 of the wire holding section 16 and the second holding element 40 (FIGS. 5 and 6). In the state of holding the electric wire, the electric wire W is held in a state of being bent due to the frictional force between the covering S of the electric wire and the peripheral edges of the through holes 34 and of the groove 38 produced by the elastic force of the electric wire W itself. At the same time, the rib 42 formed on the first plate part 18 assists at its upper surface 42a to support the electric wire W inserted in the two through holes 34.

In this state of holding the electric wire, the joint area 22 is further bent to rotate the first plate part 18 and the second plate part 20 in the directions in which they approach each other with the joint area 22 as a center. Then, the pair of insulation-displacing elements 30 move along the inner surfaces of the pair of first holding elements 36, and bite at their wire introduction edges 32a (FIG. 2) of the slots 32 into the covering S of the electric wire W that is supported by the through holes 34 and by the rib 42. As the two plate parts 18 and 20 are further rotated relative to each other, the two insulation-displacing elements 30 simultaneously penetrate through the covering S of the electric wire W at two places to come into conductive contact with the wire conductor C introduced into the slots 32 under pressure. The connection of the wire-terminal element 10 and the electric wire W is completed at a moment when the central region 18a of the first plate part 18 and the central region 2a of the second plate part 20 are brought close and arranged nearly in parallel with each other (FIGS. 7 and 8). During this rotating operation, the pair of pawls 48 of the second plate part 20 are brought into contact with the pair of receiving pieces 46 of the first plate part 18, whereby the receiving pieces 46 are elastically deflected outward. At a moment when the pawls 48 exceed the receiving pieces 46, the receiving pieces 46 elastically return, and the lower edges 46a of the receiving pieces 46 engage with the upper edges 48a of the pawls 48 to securely lock the two plate parts 18 and 20 at a position where the connection of the electric wire is completed.

At the position where the connection of the electric wire is completed, the wire-terminal element 10 holds the electric wire W in a bent manner at the wire holding section 16. The pair of insulation-displacing elements 30 come into conductive contact with the conductor C penetrating through the covering S on the terminal side beyond the bent region of the electric wire W. In this state, even when an external force such as tensile force is exerted on the electric wire W, the external force is blocked by the region where the electric wire W is bent nearly at right angles between the first holding element 36 and the second holding element 40 reliably avoiding such an occurrence that the external force is directly exerted on the portions where the two insulation-displacing elements 30 are brought into contact with the conductor C. In rotating the first and second plate parts 18 and 20 relative to each other, further, the flat central regions 18a and 20a of the two plate parts 18 and 20 need simply be pressed in the directions to approach each other. Therefore, the operation for connecting the electric wire can be carried out quickly by using a general-purpose tool such as a cutting pliers having flat grip surfaces for pressing. Besides, the tool does not substantially touch the electric wire W excluding a probability of damaging the electric wire W.

The wire-terminal element 10 having the above constitution has employed the wire connecting section 14 having the insulation-displacing elements 30. Even when a small electric wire W (e.g., AWG 28) is connected the covering S does not need to be removed and the electrical connection is done safely. Because the pair of insulation-displacing elements 30 are connected to the electric wire W at two places, the electrical connection even to the electric wire W of a small size is accomplished maintaining stability and reliability. The terminal attachment section 12 having the engaging element 24 minimizes the size (particularly, in the lengthwise direction) of the wire-terminal element 10 and enables easy terminal attachment. Therefore, the wire-terminal element 10 can be used even in applications where there is a limit on the space for installing the wire-terminal element 10. Further, the wire-terminal element 10 effectively prevents the external force such as tensile force of the electric wire W from being directly exerted on the wire connecting section through the insulation-displacing elements 30, while enabling the electric wire connection operation to be carried out properly and quickly by using a generally used tool.

FIGS. 9 to 12 illustrate a wire-terminal element 50 according to a second embodiment of the present invention. The wire-terminal element 50 includes a terminal attachment section 52 mounted on the terminal part (not shown), a wire connecting section 54 connected to the electric wire W (FIG. 13), and a wire holding section 56 arranged so as to move relative to the wire connecting section 54 and for holding the electric wire W. The wire-terminal element 50 has a unitary structure that is punched in a predetermined shape from a metal plate having good electric conductivity and is bent. There are provided a first plate part 58 of an elongated shape having the terminal attachment section 52 and the wire connecting section 54 arranged in a fixed manner at predetermined positions and a second plate part 60 of an elongated shape having the wire holding section 56 arranged in a fixed manner at a predetermined position via a joint area 62 integrally extending between the ends in the lengthwise direction, in a manner to be moved in parallel relative to each other and facing each other. Namely, in this embodiment, the wire connecting section 54 and the wire holding section 56 are coupled together in a manner to be moved in parallel relative to each other.

The terminal attachment section 52 of the wire-terminal element 50 has substantially the same constitution as the terminal attachment section 12 of the wire-terminal element 10 of the above-mentioned first embodiment, and has an engaging element 64 that mechanically engages with the terminal part (e.g., bolt and seat plate) provided on an object to which the electric wire W is to be connected. The engaging element 64 has an open-ended opening 68 defined between a pair of arms 66. The details of the terminal attachment section 52 are substantially the same as the terminal attachment section 12 and are not described here again.

The wire connecting section 54 of the wire-terminal element 50 is arranged in a fixed manner on the flat central region 58a of the first plate part 58 relative to the terminal attachment section 52. The wire connecting section 54 has a pair of flat insulation-displacing elements 70 with slot that come into conductive contact with the conductor C (FIG. 14) penetrating through the covering S of the electric wire W. The insulation-displacing elements 70 extend nearly in parallel with each other in a direction to approach the second plate part 60 nearly at right angles with the center region 58a along both side edges of the center region 58a of the first plate part 58. Each insulation-displacing element 70 has an open slot 72 extending nearly at right angles with the main plane of the center region 58a that faces the second plate part 60. These slots 72 are arranged in alignment in position as viewed in the transverse direction of the first plate part 58. Each slot 72 is expanded in an arcuate shape on the front end side of the insulation-displacing element 70 to form a wire introduction edge 72a. In the present invention, it is allowed to omit either one of the pair of insulation-displacing elements 70 or to arrange three or more insulation-displacing elements 70 depending upon the reliability of connection required for the wire-terminal element and the cost of the material.

The wire holding section 56 of the wire-terminal element 50 is arranged over substantially the full length of the second plate part 58. The wire holding section 56 includes a pair of first holding elements 76 each having a rectangular through hole 74 in which the electric wire W can be inserted and a pair of second holding elements 80 each having a groove 78 for receiving the electric wire W.

The pair of first holding elements 76 of the wire holding section 56 are extending nearly in parallel with each other in a direction to separate away from the first plate part 58 nearly at right angles with the central region 60a along both side edges of the central region 60a of the second plate part 60. A space is defined between the central region 60a of the second plate part 60 and the two first holding elements 76 for accommodating the pair of insulation-displacing elements 70 on the first plate part 58 and the terminal region of the electric wire W of which the insulation is to be displaced. Here, slits 77 are formed in the portions where central region 60a of the second plate part 60 intersect the first holding elements 76 so that the corresponding insulation-displacing elements 70 can be smoothly inserted.

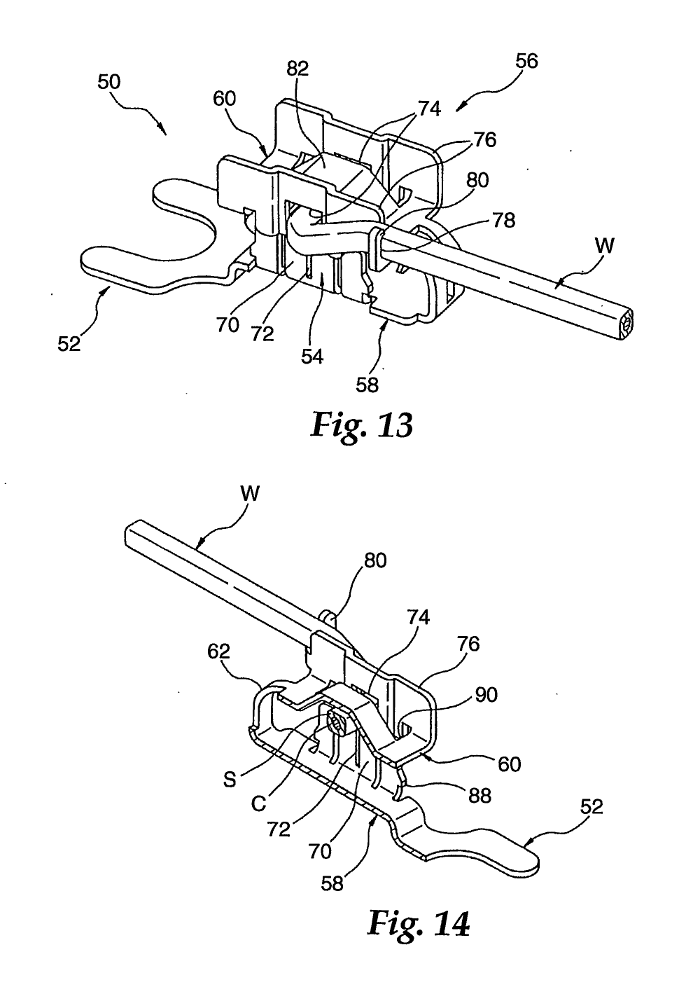

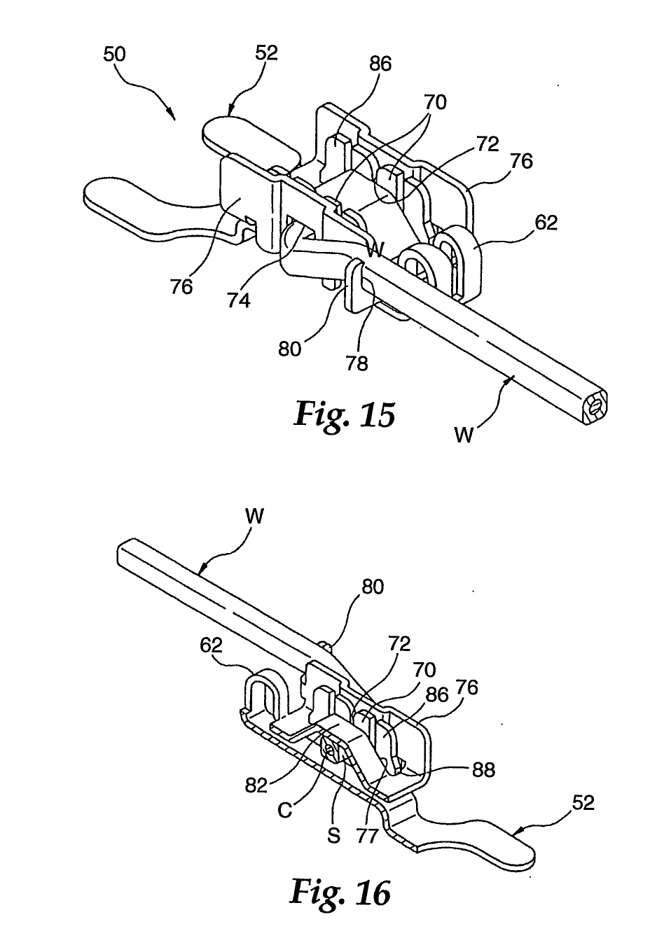

The through holes 74 in the pair of first holding elements 76 are arranged in alignment in position as viewed in the transverse direction of the second plate part 60. The gap between the two first holding elements 76 is large enough to smoothly accept the pair of insulation-displacing elements 70 of the wire connecting section 54 therebetween. Therefore, when the wire-terminal element 50 is at a position where the connection of the electric wire is completed, the pair of insulation-displacing elements 70 of the wire connecting section 54 are arranged close to the inner sides of the pair of first holding elements 76, and the slots 72 of the two insulation-displacing elements 70 are arranged in alignment passing nearly through the centers of the through holes 74 of the first holding elements 76 (FIG. 12).

The second holding element 80 of the wire holding section 56 is extending in an L-shape outward of the first holding element 76 as viewed in the transverse direction of the second plate part 60 along the edge of one first holding element 76 on the side of the joint area 62. The groove 78 of the second holding element 80 is arranged at a position extending from the plate surface of the corresponding first holding element 76 as viewed in the lengthwise direction of the second plate part 60. Therefore, while the wire-terminal element 50 is in a state of holding the electric wire as will be described later, the wire holding section 56 enables the electric wire W to be inserted in the through holes 74 in the first holding elements 76 and to be received by the groove 78 of the second holding elements 80; i.e., the electric wire W is held being bent nearly at right angles between the first holding element 76 and the second holding element 80. Even in the wire holding section 56 of the wire-terminal element 50, it is allowable to symmetrically arrange a pair of second holding elements 80 neighboring both the pair of first holding elements 76 like the wire holding section 16 of the wire-terminal element 10 described earlier.

In the illustrated embodiment, a rib 82 is formed as an auxiliary constituent element of the wire holding section 56 at a position between the through holes 74 of the two first holding elements 76 in the central region 60a of the second plate part 60. The rib 82 works on its lower surface (surface facing the first plate part 58) 82a to support, from the upper side, the electric wire W inserted in the through holes 74. Therefore, the lower surface 82a of the rib 82 is nearly at the same height as the upper edges of the through holes 74. The rib 82 further works to increase the strength of the second plate part 60.

The wire-terminal element 50 further has a locking section 84 for securely locking the first plate part 58 (wire connecting section 54) and the second plate part 60 (wire holding section 56) together. The locking section 84 is constituted by a pair of pawls 88 formed on the guide pieces 86 extending on the same plane as the insulation-displacing elements 70 on both sides of the pair of insulation-displacing elements 70 of the first plate part 58 as viewed in the lengthwise direction, and a pair of receiving edges 90 formed at both edges in the lengthwise direction of the slits 77 for inserting the insulation-25′ displacing elements on both sides of the pair of through holes 74 of the second plate part 60 as viewed in the lengthwise direction. While the first and second plate parts 58 and 60 are being moved in parallel relative to each other, the pair of guide pieces 86 extending neighboring the insulation-displacing elements 70 are received together with the insulation-displacing elements 70 by the corresponding slits 77 of the second plate part 60, and work to guide the two plate parts 58 and 60 so as to be moved in parallel relative to each other. The distance between the protruded ends of the pair of pawls 88 formed on the guide pieces 86 is slightly larger than the gap between the pair of receiving edges 90 formed at both edges in the lengthwise direction of the corresponding slits 77. When the wire-terminal element 50 is at a position where the connection of electric wire is completed as will be described later, therefore, the locking section 84 is such that the pair of pawls 88 formed on the first plate part 58 are engaged at their upper edges (edges on the side of the central region 58a) 88a with the upper surfaces 90a of the pair of receiving edges 90 formed on the second plate part 60, whereby the two plate parts 58 and 60 are securely locked at the position where the connection of the electric wire is completed.

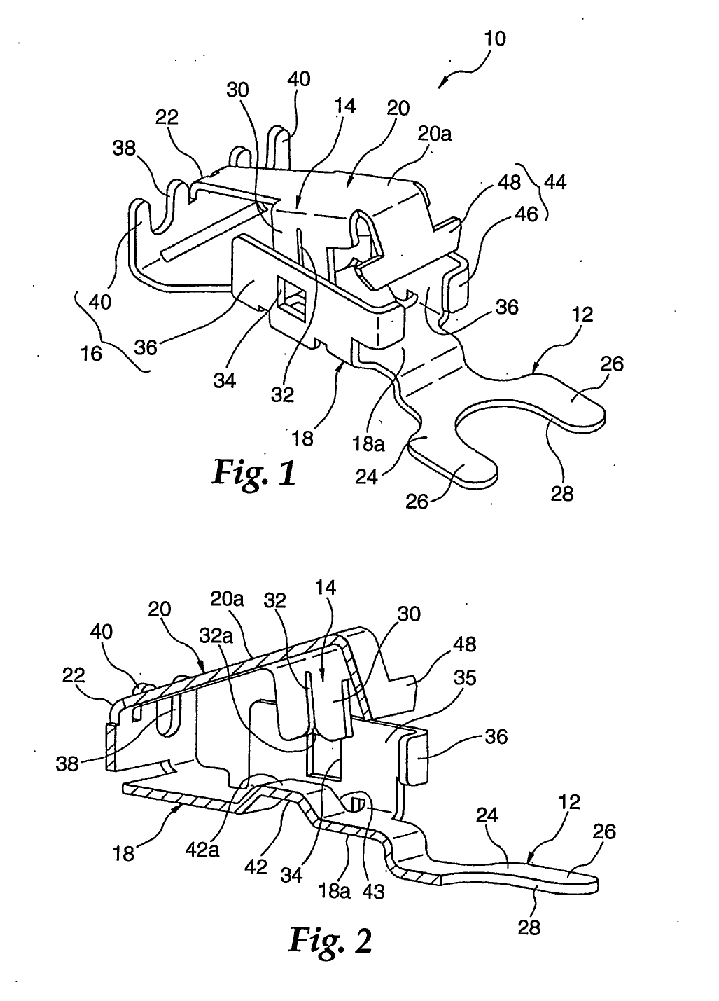

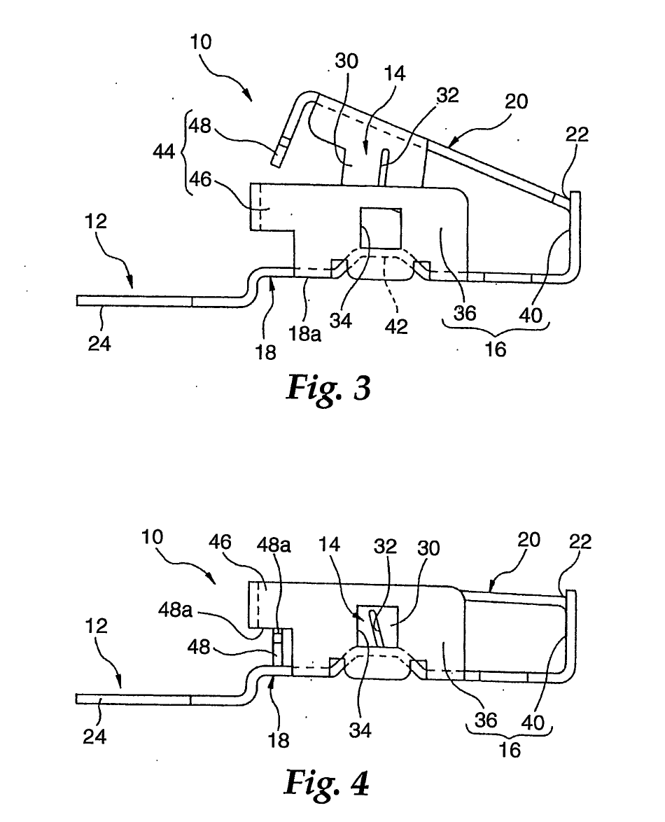

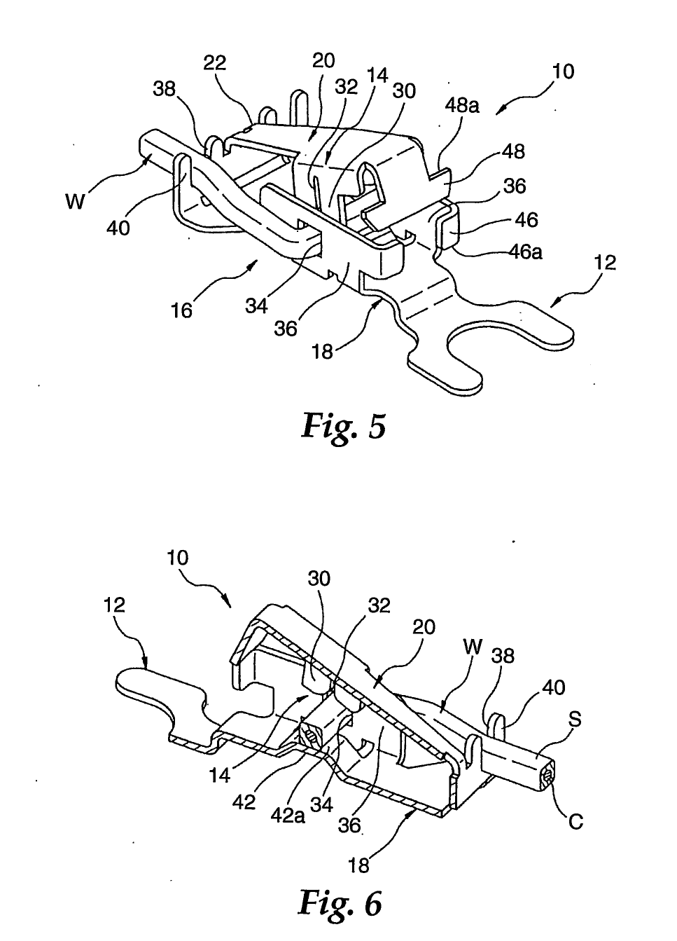

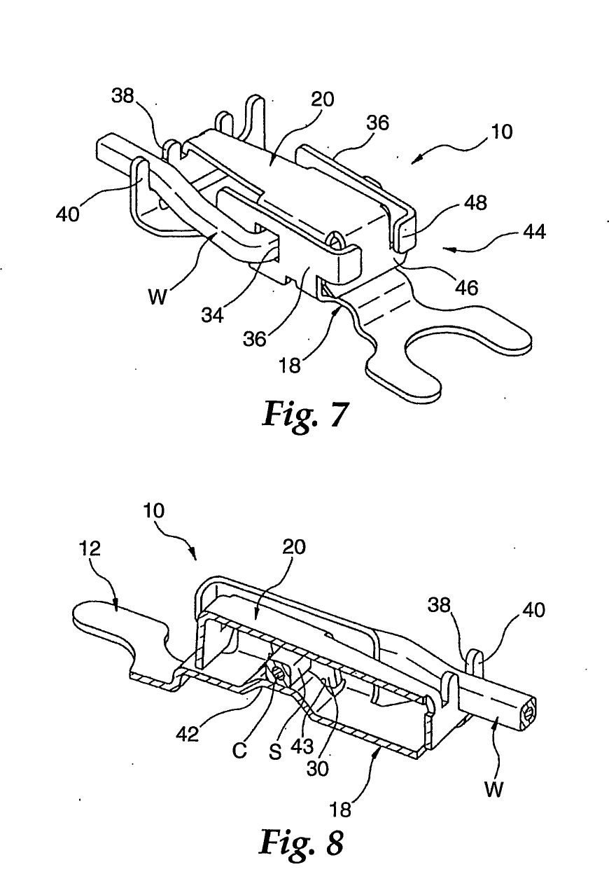

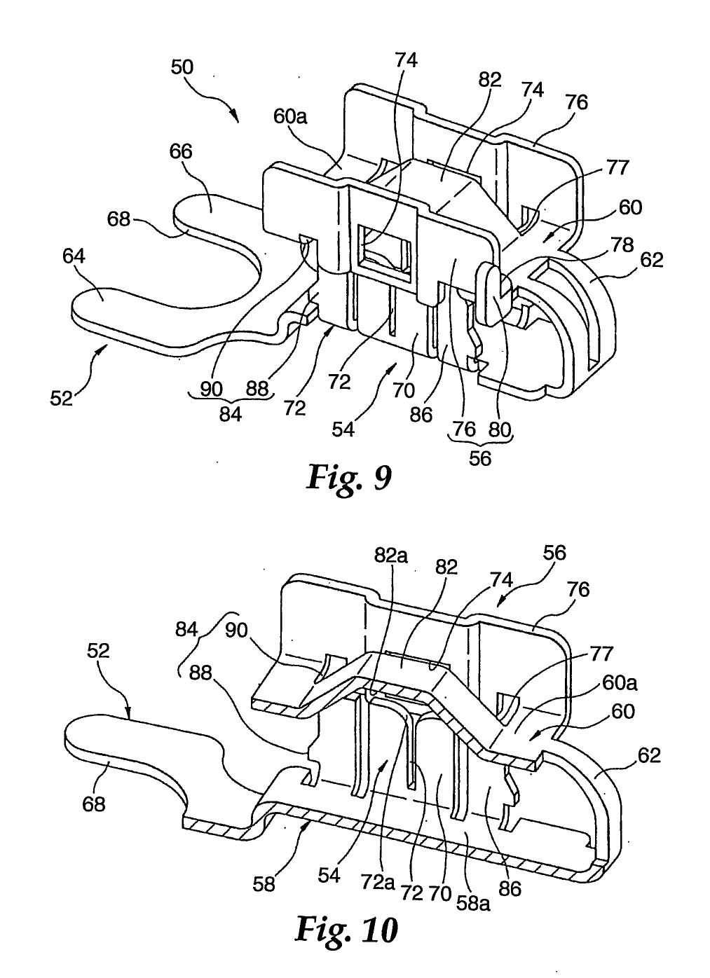

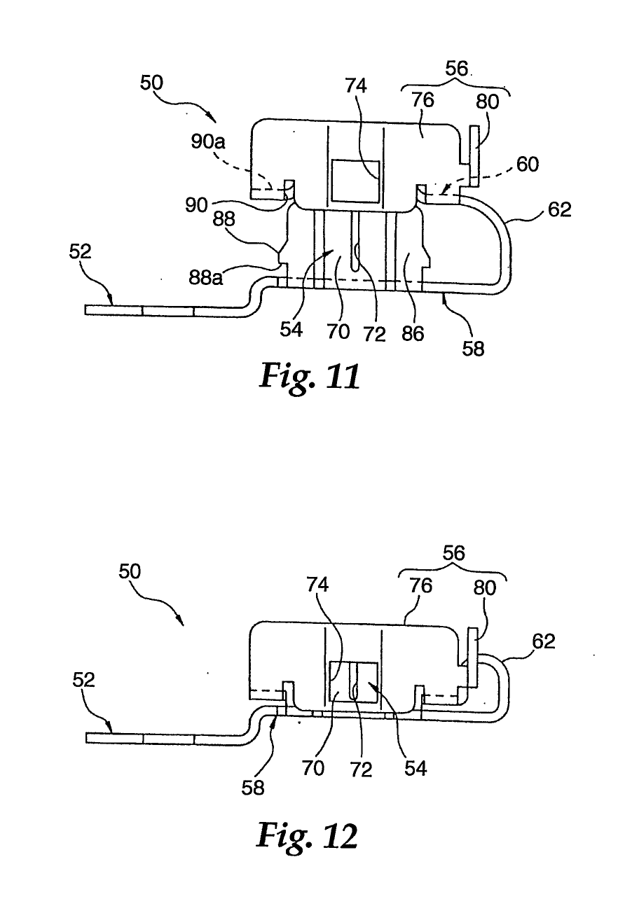

Described below with reference to FIGS. 13 to 16 is a procedure for connecting (mounting) the wire-terminal element 50 constituted as described above to the electric wire W. At a preparatory position (FIGS. 9 and 11) of the wire-terminal element 50 of before being connected to the electric wire W, the central region 58a of the first plate part 58 and the central region 60a of the second plate part 60 are separated away from each other and in parallel with each other via the joint area 62 that is deflected arcuately. At this preparatory position, the pair of insulation-displacing elements 70 of the wire connecting section 54 are placed at positions where they are not overlapping the through holes 74 of the pair of first holding elements 76 of the wire holding section 56, and the two through holes 74 are opened substantially entirely. At the preparatory position, further, the pair of insulation-displacing elements 70 and two sets of guide pieces 86 are placed at positions of not being substantially inserted in the corresponding slits 77 formed in the second plate part 60.

At the preparatory position, an end region of the electric wire W that is to be connected is inserted in the two through holes 74 that are open of the wire-terminal element 50 from the outer side of one first holding element 76, and a succeeding arbitrary portion of the electric wire W is received by the groove 78 of the second holding element 80. Then, the electric wire W is held in a state of being bent nearly at right angles between the first holding element 76 of the wire holding section 56 and the second holding element 80 (FIGS. 13 and 14). In the state of holding the electric wire, the electric wire W is held in a state of being bent due to the frictional force between the covering S of the electric wire and the peripheral edges of the through holes 74 and of the groove 78 produced by the elastic force of the electric wire W itself. At the same time, the rib 82 formed on the second plate part 60 assists at its lower surface 82a to support the electric wire W inserted in the two through holes 74.

In this state of holding the electric wire, the joint area 62 is further deflected to move the first plate part 58 and the second plate part 60 in parallel in the directions in which they approach each other being guided by the guide pieces 86. Then, the pair of insulation-displacing elements 70 are inserted in the slits 77 of the second plate-part 60 and move along the inner surfaces of the pair of first holding elements 76, and bite at their wire introduction edges 72a (FIG. 10) of the slots 72 into the covering S of the electric wire W that is supported by the through holes 74 and by the rib 82. As the two plate parts 58 and 60 are further moved in parallel relative to each other, the two insulation-displacing elements 70 simultaneously penetrate through the covering S of the electric wire W at two places to come into conductive contact with the wire conductor C introduced into the slots 72 under pressure. The connection of the wire-terminal element 50 and the electric wire W is completed at a moment when the central region 58a of the first plate part 58 and the central region 60a of the second plate part 60 are brought close and arranged nearly in parallel with each other (FIGS. 15 and 16). During this operation of parallel translation, the two sets of pawls 88 of the first plate part 58 are brought into contact with the two sets of receiving edges 90 of the second plate part 60, and the corresponding guide pieces 86 are elastically deflected. At a moment when the pawls 88 exceed the receiving edges 90, the guide pieces 86 elastically return, and the lower edges 88a of the pawls 88 engage with the upper surfaces 90a of the receiving edges 90 to securely lock the two plate parts 58 and 60 at a position where the connection of the electric wire is completed.

At the position where the connection of the electric wire is completed, the wire-terminal element 50 holds the electric wire W in a bent manner at the wire holding section 56, and the pair of insulation-displacing elements 70 come into conductive contact with the conductor C penetrating through the covering S on the terminal side beyond the bent region of the electric wire W. In this state, even when an external force such as tensile force is exerted on the electric wire W, the external force is blocked by the region where the electric wire W is bent nearly at right angles between the first holding element 76 and the second holding element 80 reliably avoiding such an occurrence that the external force is directly exerted on the portions where the two insulation-displacing elements 70 are brought into contact with the conductor C. In moving the first and second plate parts 58 and 60 in parallel relative to each other, further, the flat central regions 58a of the first plate part 58 and the horizontal upper edges of the first holding elements 76 of the second plate part 60 may simply be pressed in the directions to approach each other. Therefore, the operation for connecting the electric wire can be carried out quickly by using a general-purpose tool such as a cutting pliers having flat grip surfaces for pressing. Besides, the tool does not substantially touch the electric wire W excluding a probability of damaging the electric wire W.

It will be understood the wire-terminal element 50 having the above-mentioned constitution performs substantially the same the wire-terminal element 10. In the wire-terminal element 50 the first plate part 58 (wire connection section 54) and the second plate part 60 (wire holding section 56) are moved in parallel with each other such that the pair of insulation-displacing elements 70 displaces the insulation of the electric wire W. As compared to the first embodiment in which the two plate parts are rotated relative to each other, therefore, the full length of the wire-terminal element 50 in the lengthwise direction (in particular, the distance between the joint area 62 and the slots 72 or the through holes 74) can be eliminated. In the constitution of the first embodiment, a certain amount of distance must be maintained between the joint area 22 and the slots 32 or the through holes 34, such that the locus of motion of the slot 32 of the insulation-displacing element 30 relative to the wire conductor C is approximated to a straight line as much as possible at the time of connecting the electric wire. In the wire-terminal element 50, further, the terminal attachment section 52 and the wire connection section 54 are arranged in a fixed manner without spanning across the joint area 62. Therefore, the terminal attachment section 52 and the wire connection section 54 can be connected to each other maintaining stability and relatively small electric resistance. In this constitution, electrical connection between the terminal attachment section 52 and the wire connection section 54 is not affected even in case the joint area 62 is damaged. Therefore, the wire-terminal element 50 features further improved electrical connection. Here, however, the wire-terminal element 50 is obtained by pressing a sheet metal.

Though preferred embodiments of the invention were described above, it should be noted that the invention is in no way limited to the illustrated constitutions only but can be modified in a variety of ways. For instance, the wire-terminal element of the invention can be constituted even by joining together a plurality of constituent elements separately formed from a metal plate instead of using the illustrated constitution of a unitary structure punched in a predetermined shape from a metal plate and is bent.

According to the present invention as will be obvious from the foregoing description, it is made possible to maintain safe and proper electric connection to the electric wire in the wire-terminal element irrespective of the size of the electric wire that is to be connected as well as to prevent the external force such as tensile force of the electric wire from being directly exerted on the portion of connection to the electric wire conductor. The wire-terminal element can be further preferably employed even in such applications where limitation is imposed on the size of space for installing the electric-wire terminal, enabling the electric wire connection operation to be carried out properly and quickly by using a generally employed tool. The above wire-terminal element can be particularly preferably applied to the electric wires W of sizes of as fine as about AWG 28.

1. A wire-terminal element comprising a terminal attachment section attachable to a terminal part, a wire connecting section connectable to an electric wire, and a wire holding section for holding the electric wire, characterized in that:
said terminal attachment section includes an engaging element engageable with the terminal part;
said wire connecting section includes a slotted flat insulation-displacing element capable of conductively contacting a conductor by penetrating through a covering of the electric wire;
said wire holding section includes a holding element for holding the electric wire in a bent manner;
said wire connecting section and said wire holding section are arranged movably relative to each other; and
said insulation-displacing element and said holding element holding the electric wire move relative to each other, so that said insulation-displacing element comes into conductive contact with the conductor of the electric wire at a distal end length adjacent to a bent region of the electric wire.

2. A wire-terminal element according to claim 1, wherein said holding element includes a first holding element having a through hole into which the electric wire is insertable and a second holding element having a groove spaced from said through hole and capable of receiving the electric wire, the electric wire being bent between said first holding element and said second holding element.

3. A wire-terminal element according to claim 1, wherein said terminal attachment section and said wire holding section are arranged in a fixed manner relative to each other.

4. A wire-terminal element according to claim 1, wherein said terminal attachment section and said wire connecting section are arranged in a fixed manner relative to each other.

5. A wire-terminal element according to claim 1, wherein said wire connecting section and said wire holding section are coupled together in a rotatable manner relative to each other.

6. A wire-terminal element according to claim 1, wherein said wire connecting section and said wire holding section are coupled together in a movable manner while keeping a parallel correlation relative to each other.

7. A wire-terminal element according to claim 1, having a unitary structure that is punched from a metal plate and is bent.
